(19) United States
(12) Patent Application Publication
(10) Pub. No.: US 2026/0087206 A1
(43) Pub. Date: Mar. 26, 2026

(54) SIMULATION METHOD OF RESIN CURING REACTION

(71) Applicant: KABUSHIKI KAISHA TOSHIBA, Tokyo (JP)

(72) Inventor: Daisuke HIRATSUKA, Yokohama (JP)

(73) Assignee: KABUSHIKI KAISHA TOSHIBA, Tokyo (JP)

(21) Appl. No.: 19/270,547

(22) Filed: Jul. 16, 2025

(30) Foreign Application Priority Data
Sep. 20, 2024 (JP) 2024-163491

(51) Int. Cl. G06F 30/27; G01N 21/35; G06F 17/13; G06F 119/08; G06F 119/12

(52) U.S. Cl. CPC G06F 30/27; G01N 21/35; G06F 17/13; G01N 2021/3595; G06F 2119/08; G06F 2119/12

(57) ABSTRACT

A simulation method of a resin curing reaction, includes estimating a cure degree of a resin included in a plurality of workpieces inside a furnace by performing a coupled analysis including a thermal fluid analysis and an analysis of a master curve, the master curve representing a relationship between a temperature history and the cure degree of the resin, and based on a result of the estimating, extracting a portion having slowest curing of the resin among the plurality of workpieces.

### CROSS-REFERENCE TO RELATED APPLICATIONS

This application is based upon and claims the benefit of priority from Japanese Patent Application No. 2024-163491, filed on Sep. 20, 2024; the entire contents of which are incorporated herein by reference.

### FIELD

Embodiments described herein relate generally to a simulation method of a resin curing reaction.

### BACKGROUND

There are cases where a resin is thermoset when manufacturing an industrial product such as a semiconductor product or the like. The cure degree of the resin can be measured by differential scanning calorimetry (DSC) or Fourier transform infrared spectroscopy (FT-IR). However, these methods require a considerable amount of time and labor to search for heat treatment conditions because only one workpiece at a time can be measured. Therefore, a simulation method of the resin curing reaction is desirable.

### BRIEF DESCRIPTION OF THE DRAWINGS

FIG. 1 is a flowchart showing a generation method of a master curve according to an embodiment;

FIG. 2A is a graph showing DSC measurement results, in which the horizontal axis is the temperature, and the vertical axis is the heat generation amount; and FIG. 2B is a graph showing a relationship between the cure degree of the resin and the heat amount, in which the horizontal axis is the cure degree of the resin, and the vertical axis is the heat amount of a peak portion;

FIG. 3A is a graph showing FT-IR measurement results, in which the horizontal axis is the wave number, and the vertical axis is the absorbance; and FIG. 3B is a graph showing a relationship between the cure degree of the resin and the peak intensity, in which the horizontal axis is the cure degree of the resin, and the vertical axis is the peak intensity corresponding to the absorption of an epoxy group;

FIG. 4A is a graph showing DSC or FT-IR measurement results, in which the horizontal axis is the temperature or time, and the vertical axis is the cure degree of the resin; and FIG. 4B is a graph showing a master curve, in which the horizontal axis is a temperature history θ shown logarithmically, and the vertical axis is the cure degree of the resin;

FIG. 5 shows the object of the simulation according to the embodiment;

FIG. 6 is a flowchart showing the simulation method according to the embodiment;

FIGS. 7A and 7B show simulated results according to the embodiment; FIG. 7A shows the temperature distribution of multiple workpieces placed inside a furnace; and FIG. 7B shows cure degrees of resin portions included in the multiple workpieces;

FIGS. 8A and 8B are graphs showing the curing reaction of the resin, in which the horizontal axis is time, and the vertical axis is the reaction rate; FIG. 8A shows the portion having the fastest curing; and FIG. 8B shows the portion having the slowest curing; and

FIGS. 9A and 9B are graphs showing the curing behavior of the portion having the slowest curing, in which the horizontal axis is time, and the vertical axis is the temperature and cure degree of the resin; FIG. 9A shows when the heat treatment is excessive; and FIG. 9B shows when the heat treatment is insufficient.

### DETAILED DESCRIPTION

In general, according to one embodiment, a simulation method of a resin curing reaction, includes estimating a cure degree of a resin included in a plurality of workpieces inside a furnace by performing a coupled analysis including a thermal fluid analysis and an analysis of a master curve, the master curve representing a relationship between a temperature history and the cure degree of the resin, and based on a result of the estimating, extracting a portion having slowest curing of the resin among the plurality of workpieces.

A simulation method of a resin curing reaction according to the embodiment will now be described.

According to the embodiment, the workpiece to be simulated is a member that includes a thermosetting resin (in the specification, also referred to as simply the “resin”), and is, for example, a semiconductor device in which a semiconductor chip is sealed by a resin. Other than the semiconductor chip and the resin, the workpiece may include metal parts such as leads, wires, bumps, and the like, and ceramic parts such as a wiring substrate, etc.

First, a master curve is generated as a preparation task of the simulation. A master curve is generated each time the type of resin included in the workpiece is modified.

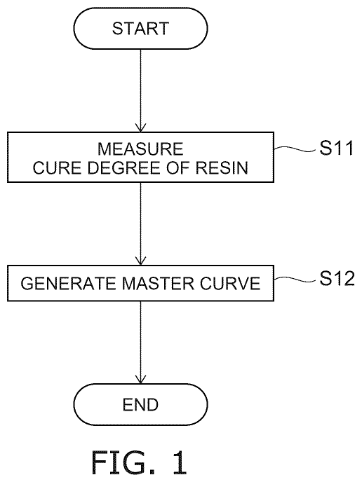

FIG. 1 is a flowchart showing a generation method of the master curve according to the embodiment.

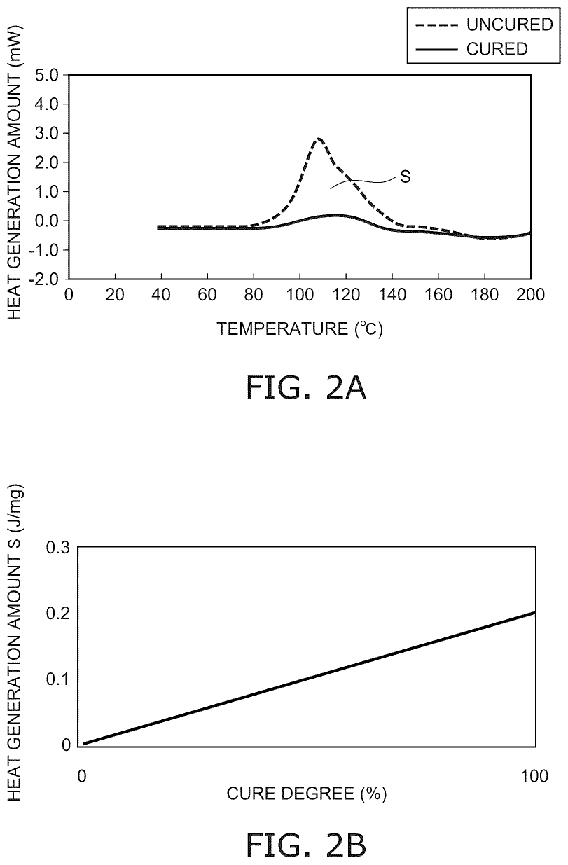

FIG. 2A is a graph showing DSC measurement results, in which the horizontal axis is the temperature, and the vertical axis is the heat generation amount; and FIG. 2B is a graph showing a relationship between the cure degree of the resin and the heat amount, in which the horizontal axis is the cure degree of the resin, and the vertical axis is the heat amount of a peak portion.

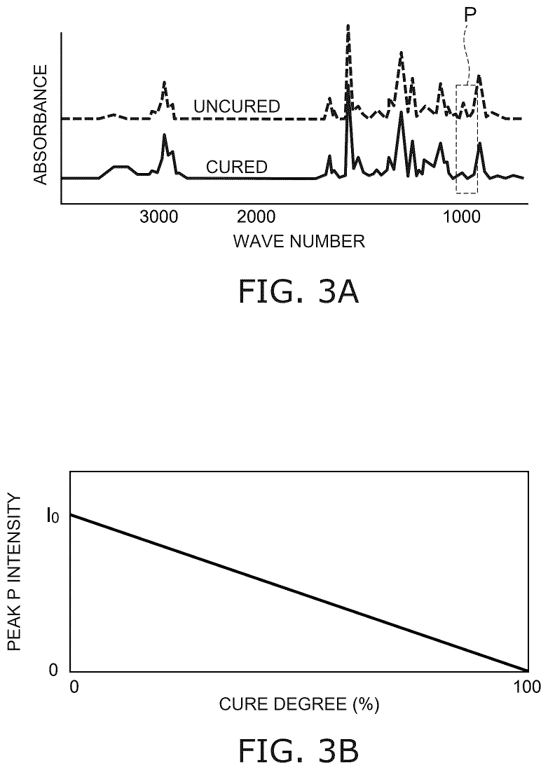

FIG. 3A is a graph showing FT-IR measurement results, in which the horizontal axis is the wave number, and the vertical axis is the absorbance; and FIG. 3B is a graph showing a relationship between the cure degree of the resin and the peak intensity, in which the horizontal axis is the cure degree of the resin, and the vertical axis is the peak intensity corresponding to the absorption of an epoxy group.

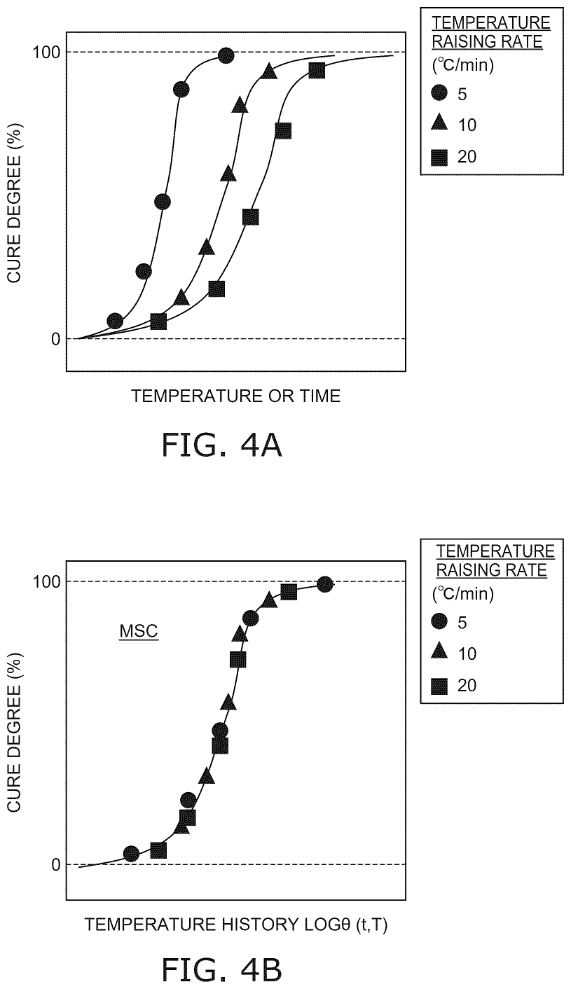

FIG. 4A is a graph showing DSC or FT-IR measurement results, in which the horizontal axis is the temperature or time, and the vertical axis is the cure degree of the resin; and FIG. 4B is a graph showing a master curve, in which the horizontal axis is a temperature history θ shown logarithmically, and the vertical axis is the cure degree of the resin.

As shown in step S11 of FIG. 1, the cure degree of the resin included in the workpiece is measured. The cure degree of the resin is an index of the degree of cure of the resin within the range of 0% to 100%, in which the uncured state is 0%, and the fully cured state is 100%.

For example, the cure degree of the resin is measured by DSC.

As shown in FIG. 2A, the area under the peak between the heat generation profile of the uncured resin and the heat generation profile of the cured resin corresponds to a total heat generation amount S accompanying the curing reaction. As shown in FIG. 2B, the total heat generation amount S increases as the curing of the resin proceeds. The cure degree of the resin when the heat generation amount S is zero is taken as 0%; the cure degree of the resin when the heat generation amount S reaches a prescribed value is taken as 100%; and a linear function is used to interpolate between 0% and 100%.

Or, the cure degree of the resin may be measured by FT-IR.

In FT-IR measurement results as shown in FIG. 3A, a peak P that indicates epoxy group C—O stretching vibration is observed. The peak P has a certain intensity for an uncured resin, and disappears for the cured resin. Therefore, as shown in FIG. 3B, the cure degree of the resin is taken as 0% when the intensity of the peak P is an initial value I₀; the cure degree of the resin is taken as 100% when the intensity of the peak P is zero; and a linear function is used to interpolate between 0% and 100%. The cure degree of the resin may be measured using methods other than DSC and FT-IR.

Then, a master curve is generated as shown in step S12 of FIG. 1.

FIG. 4A shows measurement results of the cure degree by DSC or FT-IR. As shown in FIG. 4A, the relationship between the cure degree of the resin and the temperature or time of the heat treatment applied to the resin is different according to the heat treatment conditions such as the temperature raising rate, etc. The change of the cure degree from the uncured state of the resin until the resin is completely cured is measured at least two times, and favorably not less than three times. FIG. 4A shows an example in which the change of the cure degree is measured for three different temperature raising rates. In FIG. 4A, a relationship of the temperature rising rates is shown when the horizontal axis of FIG. 4A represents temperature. When the horizontal axis of FIG. 4A represents time, the relationship of the temperature rising rates is reversed.

As shown in FIG. 4B, one master curve MSC is generated from the multiple measurement results shown in FIG. 4A. The master curve MSC is a function of the relationship between the temperature history and the cure degree. For example, the master curve MSC is represented by the following Formula 1. In the following Formula 1, t is time, T is the temperature, Q is the activation energy, R is the gas constant, and the temperature history θ(t, T) is the sum total of the temperature history from the start timing of the heat treatment to an arbitrary time t and temperature T. The master curves MSC are different according to the type of resin.

$$θ ( t , T ) = {\int }_{0}^{t} exp ( - \frac{Q}{RT} ) dt \qquad [ Formula 1 ]$$

A simulation method of the resin curing reaction according to the embodiment will now be described.

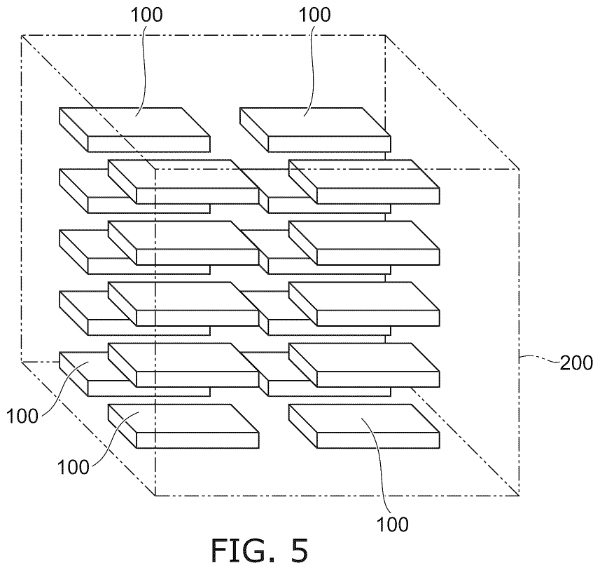

FIG. 5 shows the object of the simulation according to the embodiment.

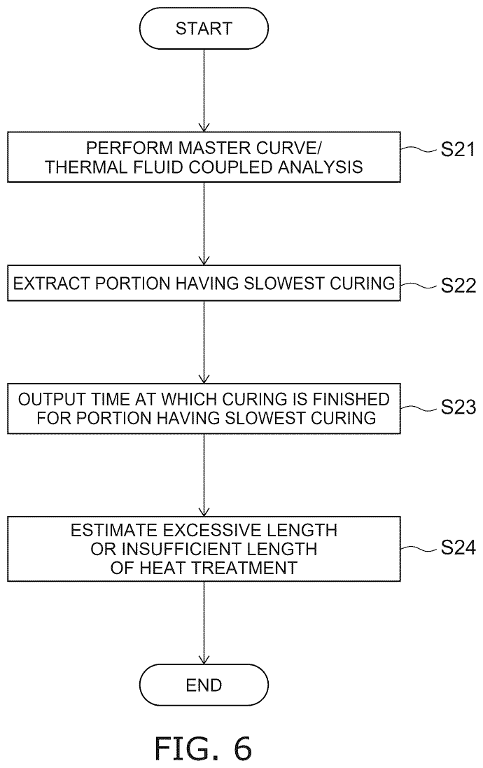

FIG. 6 is a flowchart showing the simulation method according to the embodiment.

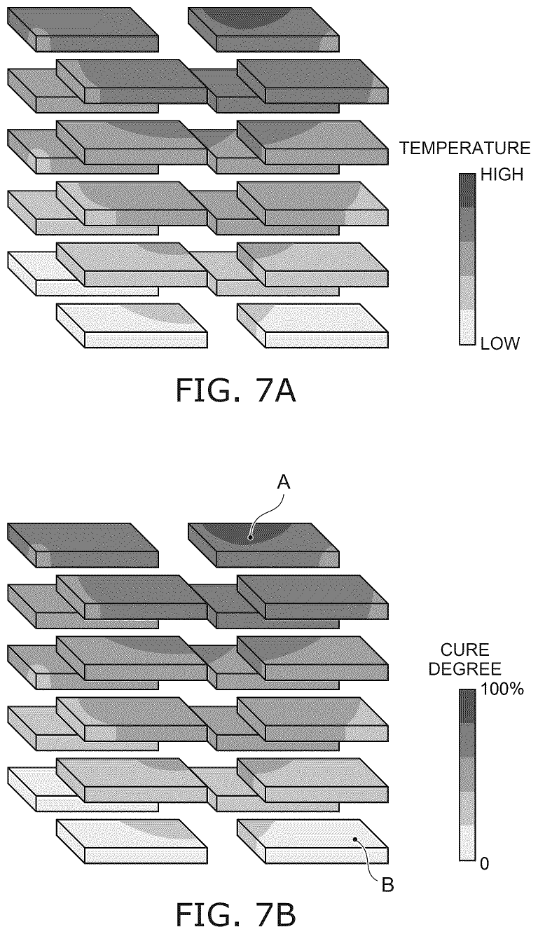

FIGS. 7A and 7B show simulated results according to the embodiment; FIG. 7A shows the temperature distribution of multiple workpieces placed inside a furnace; and FIG. 7B shows cure degrees of resin portions included in the multiple workpieces.

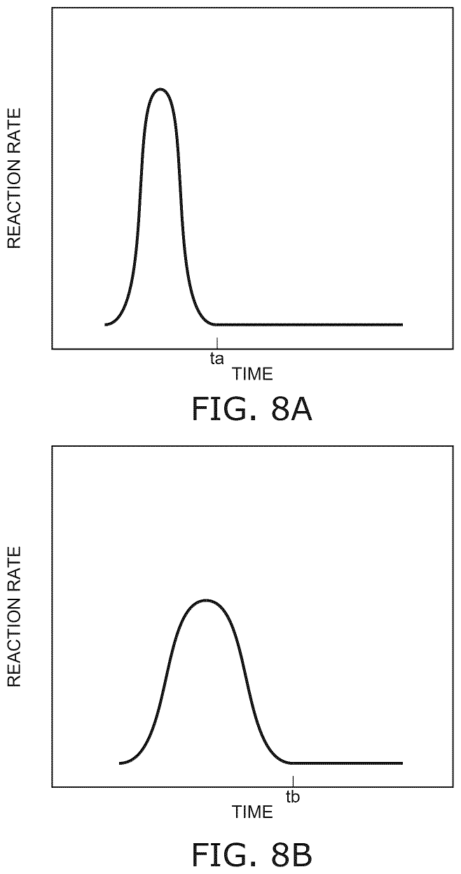

FIGS. 8A and 8B are graphs showing the curing reaction of the resin, in which the horizontal axis is time, and the vertical axis is the reaction rate; FIG. 8A shows the portion having the fastest curing; and FIG. 8B shows the portion having the slowest curing.

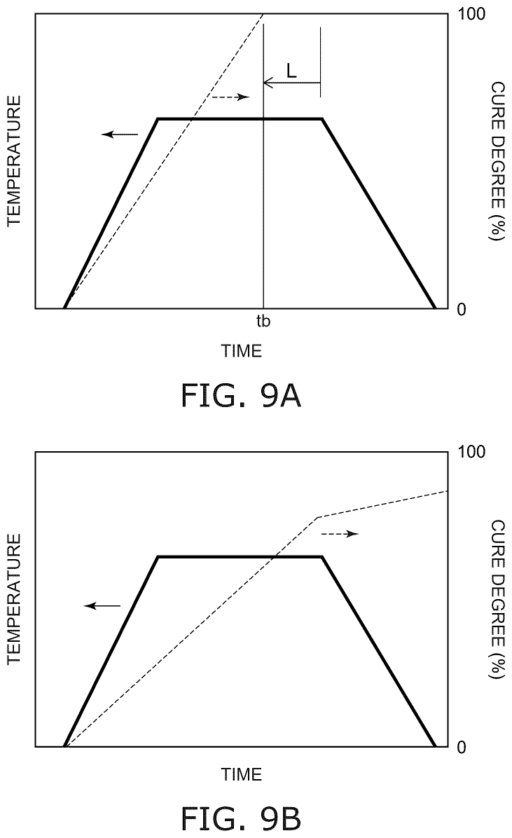

FIGS. 9A and 9B are graphs showing the curing behavior of the portion having the slowest curing, in which the horizontal axis is time, and the vertical axis is the temperature and cure degree of the resin; FIG. 9A shows when the heat treatment is excessive; and FIG. 9B shows when the heat treatment is insufficient.

According to the embodiment as shown in FIG. 5, multiple workpieces 100 that are placed inside a furnace 200 are to be cured. The furnace 200 is a heating furnace; and the interior of the furnace 200 is, for example, an ambient-air atmosphere or a nitrogen atmosphere. The workpiece 100 is a product that includes a thermosetting resin and is, for example, a semiconductor device in which a semiconductor chip is sealed by a resin. The resin is uncured in the initial state.

As shown in step S21 of FIG. 6, a coupled analysis that includes thermal fluid analysis and the master curve MSC shown in FIG. 4B is performed for the interior of the furnace 200. The temperature change of each part inside the furnace 200 is simulated by considering the three types of heat transfer of thermal conduction, convection, and radiation. The temperature change of each portion inside each workpiece 100 also is simulated by considering mainly thermal conduction.

As shown in FIG. 7A, different temperatures occur inside the furnace 200 according to the position. For example, portions proximate to a heating device (not illustrated) increase more quickly than distant portions; and the upper part inside the furnace 200 has a higher temperature than the lower part. However, such a temperature distribution is dependent on the configuration of the furnace 200. Within each workpiece 100, the metal portions have relatively high heat transfer rates; and the resin portions have relatively low heat transfer rates. The temperature distribution shown in FIG. 7A changes over time.

The cure degree of the resin is estimated based on the temperature distribution shown in FIG. 7A. At this time, Formula 1 above is used to calculate the temperature history θ(t, T) based on the temperature history from the start of the heating until any timing; and the cure degree is estimated based on the calculated temperature history θ(t, T) and the master curve MSC shown in FIG. 4B. As a result, the distribution of the cure degree of the resin at any timing is estimated as shown in FIG. 7B. The distribution of the cure degree changes over time. The portion having the fastest curing of the resin is taken as a portion A; and the portion having the slowest curing of the resin is taken as a portion B. The portions A and B are, for example, portions of mutually-different workpieces 100.

FIG. 8A shows the portion A having the fastest curing of the resin; and FIG. 8B shows the portion B having the slowest curing of the resin. As shown in FIGS. 8A and 8B, the reaction rate returns to baseline after increasing once to a maximum value. The times ta and tb at which the resin curing is completed can be determined from the time at which the degree of curing reaches 100% based on the master curve MSC.

Then, as shown in step S22 of FIG. 6, the portion B having the slowest curing of the resin is extracted from the distribution of the cure degree shown in FIG. 7B. As shown in FIG. 8B, the curing of the resin is determined to be finished for all of the workpieces 100 placed inside the furnace 200 at the time tb at which the curing is finished for the portion B having the slowest curing of the resin.

Continuing as shown in step S23 of FIG. 6, the time tb at which the curing is finished for the portion B having the slowest curing of the resin is output.

Then, as shown in step S24 of FIG. 6, the excessive length or insufficient length of the heat treatment is estimated. In FIGS. 9A and 9B, the solid line illustrates the assumed temperature profile; and the broken line illustrates the cure degree of the resin.

As shown in FIG. 9A, when the cure degree reaches 100% partway through the heat treatment, the subsequent heat treatment can be determined to be excessive. In such a case, the heat treatment time may be reduced by an excessive length L. As a result, the throughput can be improved, and the cost of the resin curing can be reduced.

As shown in FIG. 9B, when the cure degree of the portion B does not reach 100% even at the end of the heat treatment, the heat treatment can be determined to be insufficient. In such a case, new conditions are set by increasing the set temperature or increasing the set time of the heat treatment; and the simulation described above is repeated. Thus, conditions are found at which the cure degree of the portion B reaches 100%. As a result, even the resin of the slowest portion B is reliably cured, and the quality of the workpiece 100 is stabilized. Thus, the simulation of the resin curing reaction ends.

The simulation described above can be performed by a simulation program of the resin curing reaction executed by a computer. The computer may be a general-purpose machine that includes a calculation part, a storage part, an input/output part, etc., or may be a special-purpose machine.

The simulation program of the resin curing reaction according to the embodiment causes a computer to perform a step of estimating the cure degree of the resin included in the multiple workpieces 100 placed inside the furnace 200 by coupled analysis including thermal fluid analysis and analysis of a master curve MSC representing a relationship between the temperature history and the cure degree of the resin, and a step of extracting, based on the result of the estimation, the portion B having the slowest curing of the resin among the multiple workpieces 100.

Effects of the embodiment will now be described.

According to the embodiment, the cure degree of the resin can be simulated. As a result, the cure degree of the resin of any portion of the workpieces 100 inside the furnace 200 can be estimated at any timing of the heat treatment. As a result, the curing reaction of the resin can be visualized, and an excessive or insufficient heat treatment can be detected. As a result, the curing conditions of the resin can be optimized.

According to the embodiments above, a simulation method and a simulation program of a resin curing reaction can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

Embodiments include the following aspects.

### Note 1

A simulation method of a resin curing reaction, comprising:
estimating a cure degree of a resin included in a plurality of workpieces inside a furnace by performing a coupled analysis including a thermal fluid analysis and an analysis of a master curve, the master curve representing a relationship between a temperature history and the cure degree of the resin; and
based on a result of the estimating, extracting a portion having slowest curing of the resin among the plurality of workpieces.

### Note 2

The method according to note 1, wherein
the temperature history is expressed by the following formula, in which t is time, T is a temperature, R is a gas constant, Q is an activation energy, and θ(t, T) is the temperature history.

$$θ ( t , T ) = {\int }_{0}^{t} exp ( - \frac{Q}{RT} ) dt$$

### Note 3

The method according to note 2, wherein
the formula is generated based on a result of differential scanning calorimetry.

### Note 4

The method according to note 2, wherein
the formula is generated based on a measurement result of Fourier transform infrared spectroscopy.

### Note 5

The method according to any one of notes 1-4, further comprising:
outputting a time at which the curing is finished for the portion having the slowest curing of the resin.

### Note 6

A simulation program of a resin curing reaction,
the simulation program, when executed by a computer, causing the computer to:
   estimate a cure degree of a resin included in a plurality of workpieces inside a furnace by performing a coupled analysis including a thermal fluid analysis and an analysis of a master curve, the master curve representing a relationship between a temperature history and the cure degree of the resin; and
   based on a result of the estimation, extract a portion having slowest curing of the resin among the plurality of workpieces.

### Note 7

The simulation program according to Note 6, wherein
the temperature history is expressed by the following formula, in which θ(t, T) is the temperature history, t is time, T is a temperature, R is a gas constant, and Q is an activation energy.

$$θ ( t , T ) = {\int }_{0}^{t} exp ( - \frac{Q}{RT} ) dt$$

### Note 8

The simulation method according to Note 6 or 7, further comprising:
outputting a time at which the curing is finished for the portion having the slowest curing of the resin.

What is claimed is:

1. A simulation method of a resin curing reaction, comprising:
estimating a cure degree of a resin included in a plurality of workpieces inside a furnace by performing a coupled analysis including a thermal fluid analysis and an analysis of a master curve, the master curve representing a relationship between a temperature history and the cure degree of the resin; and
based on a result of the estimating, extracting a portion having slowest curing of the resin among the plurality of workpieces.

2. The method according to claim 1, wherein
the temperature history is expressed by the following formula, in which t is time, Tis a temperature, R is a gas constant, Q is an activation energy, and θ (t, T) is the temperature history.
$$θ ( t , T ) = {\int }_{0}^{t} exp ( - \frac{Q}{RT} ) dt$$

3. The method according to claim 2, wherein
the formula is generated based on a result of differential scanning calorimetry.

4. The method according to claim 2, wherein
the formula is generated based on a measurement result of Fourier transform infrared spectroscopy.

5. The method according to claim 1, further comprising:
outputting a time at which the curing is finished for the portion having the slowest curing of the resin.
